(19) United States
(12) Patent Application Publication
(10) Pub. No.: US 2026/0061857 A1
(43) Pub. Date: Mar. 5, 2026

(54) CONNECT/DISCONNECT SYSTEM AND METHOD FOR OPERATING THE SYSTEM FOR ELECTRIC VEHICLE

(71) Applicant: Ford Global Technologies, LLC, Dearborn, MI (US)

(72) Inventors: Guopeng Hu, Northville, MI (US); Zhengyu Dai, Canton, MI (US); Yanan Zhao, Ann Arbor, MI (US); Matthew John Shelton, Grosse Ile, MI (US); Jonathan Sullivan, Ferndale, MI (US)

(73) Assignee: Ford Global Technologies, LLC, Dearborn, MI (US)

(21) Appl. No.: 18/817,823

(22) Filed: Aug. 28, 2024

(51) Int. Cl. B60W 10/08; B60D 1/64; B60W 40/105

(52) U.S. Cl. CPC B60L 15/2054; B60K 23/08; B60K 2023/0875

(57) ABSTRACT

A system for an electric vehicle includes a drive axle, a motor, a sensor, a coupling, and a controller. The drive axle is configured to drive a set of vehicle wheels. The motor is configured to selectively drive the drive axle. The sensor is configured to measure a vehicle speed. The coupling is configured to move between an open position in which the motor and the drive axle are disconnected from each other and a closed position in which the motor and the drive axle are connected to each other. The controller is in communication with the motor, the sensor, and the coupling. The controller configured to: determine a vehicle speed connect value based on a vehicle operating parameter and move the coupling to the closed position in response to the vehicle speed connect value being greater than the measured vehicle speed.

### FIELD

The present disclosure relates to a connect/disconnect system and method for operating the system for an electric vehicle.

### BACKGROUND

The statements in this section merely provide background information related to the present disclosure and does not constitute prior art.

A disconnector system has been applied to vehicles such as electric vehicles and hybrid vehicles. The disconnector system refers to a device the reduces drag by controlling reverse driving force transferred from a motor to wheels. An electric vehicle with four-wheel-drive (4WD) is equipped with a disconnector on the front or rear wheels to transfer or control the driving force of the motor as desired. When the vehicle is being driven in a state in which the disconnector is disengaged, fuel efficiency is increased due to reduction in drag, but when the disconnector is engaged for vehicle control, it takes time to switch the operation mode of the disconnector from a disengaged state to an engaged state for vehicle control.

The present disclosure provides a method and a system that addresses these and other issues associated with disconnector systems.

### SUMMARY

This section provides a general summary of the disclosure and is not a comprehensive disclosure of its full scope or all of its features.

In one form, the present disclosure provides a system for an electric vehicle. The system includes a drive axle, a motor, a sensor, a coupling, and a controller. The drive axle is configured to drive a set of vehicle wheels. The motor is configured to selectively drive the drive axle. The sensor is configured to measure a vehicle speed. The coupling is configured to move between an open position in which the motor and the drive axle are disconnected from each other and a closed position in which the motor and the drive axle are connected to each other. The controller is in communication with the motor, the sensor, and the coupling. The controller configured to: determine a vehicle speed connect value based on a vehicle operating parameter and move the coupling to the closed position in response to the vehicle speed connect value being greater than the measured vehicle speed.

In variations of the system of the above paragraph, which can be implemented individually or in any combination: the vehicle speed connect value is determined based on a reference table stored in a memory of the controller; the controller is further configured to determine a vehicle speed disconnect value based on the vehicle operating parameter, the coupling is moved to the open position in response to the vehicle speed connect value being less than the measured vehicle speed and the vehicle speed disconnect value being less than the measured vehicle speed; the vehicle speed connect value is determined based on the vehicle operating parameter and the measured vehicle speed; the vehicle operating parameter is one of a pedal input, regenerative torque, and a wheel torque; and the measured vehicle speed takes into account a primary drive unit torque limit.

In another form, the present disclosure provides a system for an electric vehicle. The system includes a drive axle, a motor, a sensor, a coupling, and a controller. The drive axle is configured to drive a set of vehicle wheels. The motor is configured to selectively drive the drive axle. The sensor is configured to measure a vehicle speed. The coupling is configured to move between an open position in which the motor and the drive axle are disconnected from each other and a closed position in which the motor and the drive axle are connected to each other. The controller is in communication with the motor, the sensor, and the coupling. The controller configured to: determine a modification value based on the measured vehicle speed and a first vehicle operating parameter, determine whether the modification value is negative, adjust a second vehicle operating parameter by the modification value in response to the modification value being negative, determine a vehicle speed connect value based on the adjusted second vehicle operating parameter, and move the coupling to the closed position in response to the vehicle speed connect value being greater than the measured vehicle speed.

In variations of the system of the above paragraph, which can be implemented individually or in any combination: the modification value is determined based on a reference table stored in a memory of the controller; the first vehicle operating parameter is one of a pedal rate, regenerative torque rate, and a wheel torque rate; the vehicle speed connect value is determined based on a reference table stored in a memory of the controller; adjusting the second vehicle operating parameter by the modification value comprises increasing the second vehicle operating parameter by the modification value; the controller is further configured to determine a vehicle speed disconnect value based on the vehicle operating parameter, the coupling is moved to the open position in response to the vehicle speed connect value being less than the measured vehicle speed and the vehicle speed disconnect value being less than the measured vehicle speed; the vehicle speed connect value is determined based on the adjusted second vehicle operating parameter and the measured vehicle speed; and the second vehicle operating parameter is one of a pedal input, regenerative torque, and a wheel torque.

In yet another form, the present disclosure provides a method including determining a modification value based on a measured vehicle speed and a first vehicle operating parameter, determining whether the modification value is negative, adjusting a second vehicle operating parameter by the modification value in response to the modification value being negative, determining a vehicle speed connect value based on the adjusted second vehicle operating parameter, and moving a coupling to a closed position in response to the vehicle speed connect value being greater than the measured vehicle speed, the coupling connecting a motor and a drive axle to each other when in the closed position.

In variations of the method of the above paragraph, which can be implemented individually or in any combination: the modification value is determined based on a reference table stored in a memory of the controller; the first vehicle operating parameter is one of a pedal rate, regenerative torque rate, and a wheel torque rate; the vehicle speed connect value is determined based on a reference table stored in a memory of the controller; adjusting the second vehicle operating parameter by the modification value comprises increasing the second vehicle operating parameter by the modification value; determining a vehicle speed disconnect value based on the adjusted second vehicle operating parameter; and moving the coupling to the open position in response to the vehicle speed connect value being less than the measured vehicle speed and the vehicle speed disconnect value being less than the measured vehicle speed.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic view of a vehicle including a vehicle performance system according to the principles of the present disclosure;

FIG. 2 is a block diagram showing components of the vehicle performance system of FIG. 1; and

FIGS. 3A-3C is another flowchart depicting an algorithm of the vehicle performance system of FIG. 1 according to the principles of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

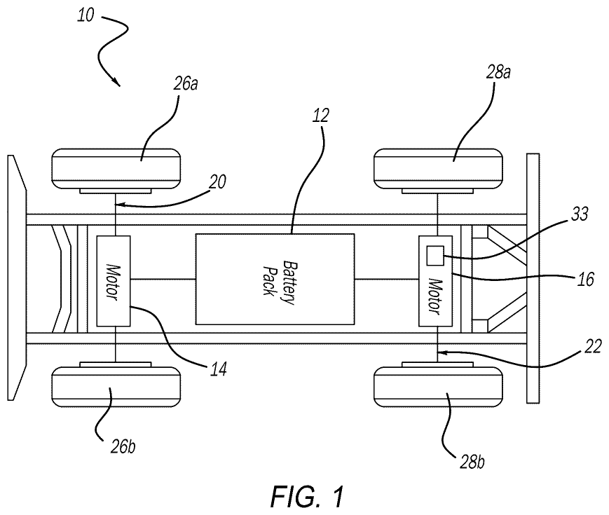

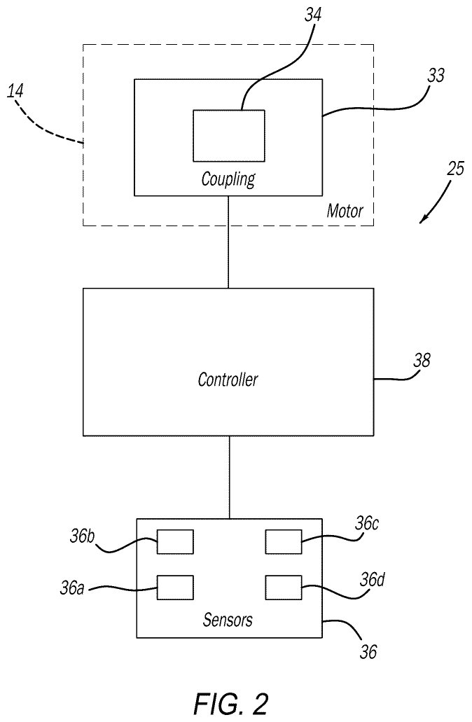

As shown in FIG. 1, a vehicle 10 such as an electric vehicle is provided. In the example provided, the electric vehicle is a battery electric vehicle (BEV). In other examples, the electric vehicle may be a hybrid electric vehicle (HEV), a plug-in electric vehicle (PHEV), or a fuel cell vehicle. The vehicle 10 includes a battery pack 12, a first or rear motor (e.g., primary drive unit) 14 such as an electric motor, a second or front motor 16 (e.g., secondary drive unit) such as an electric motor, a rear axle 20, a front axle 22, a coupling or clutch 33, and a connect/disconnect system 25 (FIG. 2). The battery pack 12 may be rechargeable and may include lithium-ion batteries or any other suitable electrical power storage units. The battery pack 12 powers the rear motor 14 to drive a set of rear wheels 26a, 26b via the rear axle 20. Similarly, the battery pack 12 powers the front motor 16 to selectively drive a set of front wheels 28a, 28b via the front axle 22. One example of such a battery pack is disclosed in application Ser. No. 17/589,273 and titled “BATTERY HOUSING FOR ELECTRIC VEHICLES,” which is commonly owned with the present application and the contents of which are incorporated herein by reference in its entirely.

The rear motor 14 may drive the rear wheels 26a, 26b at the same speed or at different speeds, such as with a differential (not shown) for example. Similarly, the front motor 16 may drive the front wheels 28a, 28b at the same speed or at different speeds, such as with a differential (not shown) for example. When the rear motor 14 drives the rear wheels 26a, 26b and the front motor 16 is decoupled from the front wheels 28a, 28b, and therefore, are not driving the front wheels 28a, 28b, the vehicle 10 is in a two-wheel-drive mode. When the rear motor 14 drives the rear wheels 26a, 26b and the front motor 16 is coupled to and driving the front wheels 28a, 28b, the vehicle 10 is in a four-wheel-drive mode. While the wheels 28a and 28b are described herein as front wheels and the wheels 26a and 26b are described herein as rear wheels, the principles of the present disclosure also apply when the wheels 28a and 28b are rear wheels and the wheels 26a and 26b are front wheels such that the motor 16 is a rear motor and the motor 14 is a front motor. It is also understood that the principles of the present disclosure can apply to vehicles with more than four wheels.

The coupling 33 has an output member (not specifically shown) that is selectively drivingly connected to the front axle 22 to provide rotary power thereto. That is, the coupling 33 may be associated with the front motor 16 and may be configured to selectively provide rotary power generated by the front motor 16 to the front axle 22 to drive the wheels 28a, 28b. The coupling 33 is movable between a first or closed position in which the output member and the front axle 22 are engaged to transmit rotary power from the front motor 16 to the front axle 22 and a second or open position in which the output member and the front axle 22 are disengaged from each other so that rotary power is not transferred from the front motor 16 to the front axle 22. In one form, the coupling 33 is a dog clutch and the front axle 22 has a member having mating teeth that are engaged when the coupling 33 is in the first position and disengaged when the coupling 33 is in the second position. When the coupling 33 is in the first position, the vehicle 10 is in the four-wheel-drive mode (or all wheel drive), and when the coupling 33 is in the second position, the vehicle 10 is in the two-wheel-drive mode. An actuator 34 is operable to move the coupling 33 between the first position and the second position. For example, the actuator 34 can be coupled to the front axle 22 or the front motor 16 to move the coupling 33. The actuator 34 can be any suitable type of actuator (e.g., a linear actuator, a solenoid, a piston cylinder, a rotary actuator).

With reference to FIG. 2, the system 25 includes the motor 14, sensors 36a, 36b, 36c, 36d (collectively referred to as sensors 36) and one or more controllers 38. The sensors 36a are configured to measure a speed of the vehicle 10. The sensors 36b are associated with an pedal (not shown) of the vehicle 10 and is configured to measure a pedal input (i.e., a depression of the pedal) and/or a pedal rate (i.e., change in pedal position/time). For example, if a user of the vehicle 10 goes from an pedal rest position to an pedal fully depressed position, then the pedal input may be 100%, for example. If a user of the vehicle 10 goes from the pedal rest position to the pedal fully depressed position in one (1) second then the pedal rate would be lower than if the user goes from the pedal rest position to the pedal fully depressed position in one (1) millisecond.

The sensors 36c are associated with the motors 14, 16 and may be configured to measure regenerative braking torque (i.e., torque by the motors 14, 16 to recuperate kinetic energy) and/or regenerative braking torque rate (i.e., change in regenerative braking torque per second) produced by the motors 14, 16. That is, the motors 14, 16 may be used as generators that charge the battery pack 12 by generating a back electromotive force when a state of charge (SOC) is insufficient or in the case of regenerative braking. Regenerative braking converts vehicle kinetic energy into electricity that is stored within the battery pack 12. The sensors 36d are associated with the wheels 26a, 26b, 28a, 28b or axles 20, 22 and are configured to measure wheel torque or input and/or wheel torque rate. That is, the wheel torque is the torque on the wheels to produce the desired drive characteristics (e.g., desired vehicle speed). The wheel torque rate is the change in wheel torque per second.

The controller 38 is in communication (wired or wireless) with the sensors 36a, 36b, 36c, 36d, the motors 14, 16, and the coupler 33 (actuator 34 of coupler 33). The controller 38 may determine a vehicle speed connect value and a vehicle speed disconnect value based on the measured vehicle speed and one or more vehicle operating parameters (e.g., the measured pedal input, measured pedal rate, measured regenerative braking toque, measured regenerative braking torque rate, measured wheel torque, and measured wheel torque rate). The controller may then compare the vehicle speed connect value and the vehicle speed disconnect value to the measured vehicle speed to operate the coupler 33 (e.g., the controller 38 may operate the actuator 34 to move the coupling between the first position and the second position). In some forms, other vehicle operating parameters may be used and compared to operate the actuator 34 to move the coupling 33 between the first position and the second position.

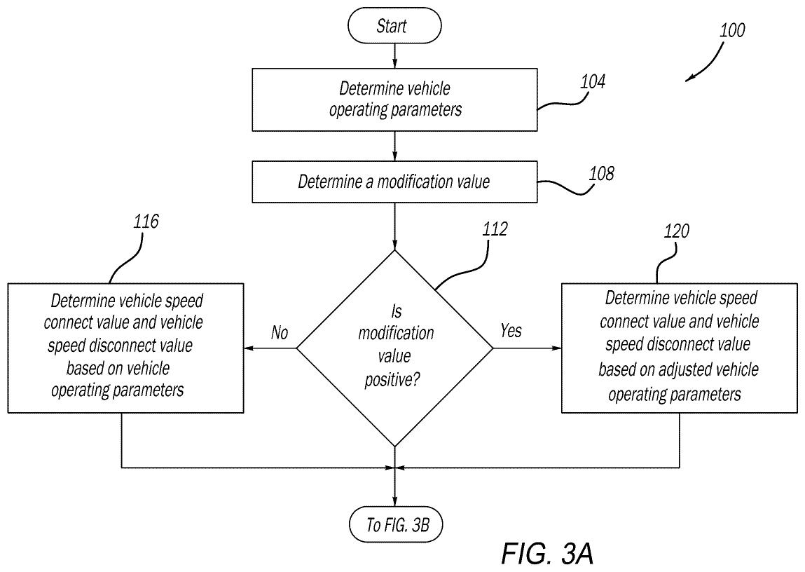

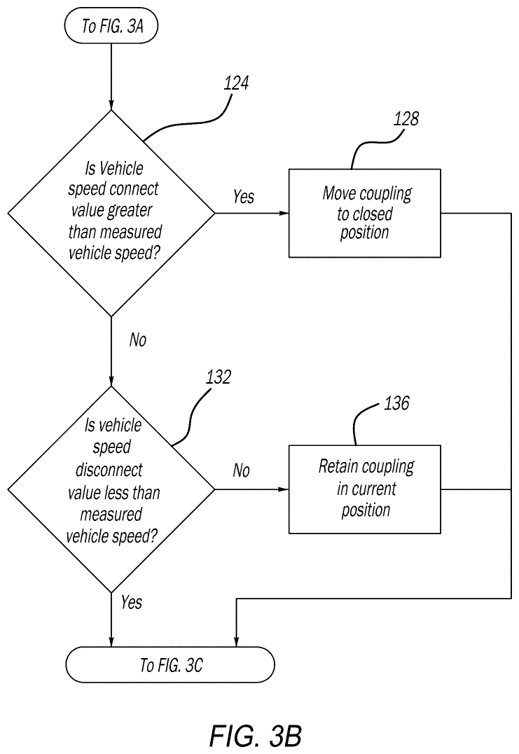

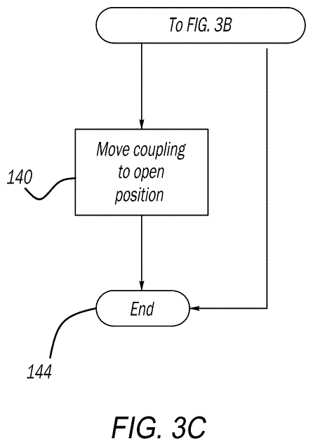

With reference to FIGS. 3A-3C, a method 100 showing an example implementation of a control algorithm (e.g., method) for operating the connect/disconnect system 25 is illustrated. That is, to increase the vehicle 10 range and energy efficiency, the connect/disconnect system 25 may be included (e.g., integrated) in the front axle 22 and the front motor 16 of the vehicle 10. As described in further detail below, in one form, the front motor 16 can be disconnected from the front axle 22 (i.e., driveline) so that the front motor 16 drag loss can be removed from the front axle 22, thereby, increasing the energy efficiency and range of the vehicle 10. When the coupling 33 is desired to be connected to the front axle 22, it is advantageous for the connection to occur as quickly as possible such that the front motor 16 provides propulsion or regenerative torque at the time desired. The method below describes an example implementation for operating the connect/disconnect system 25 as desired.

At 104, the control algorithm, using the controller 38, determines or measures vehicle operating parameters. That is, the controller 38 may determine or measure the speed of the vehicle using the sensors 36a, the pedal input and the pedal rate using the sensors 36b, the regenerative breaking torque and the regenerative breaking torque rate using the sensors 36c, and/or the wheel torque and wheel torque rate using the sensors 36d. It should be understood that the primary drive unit 14 has a torque capacity limitation at high motor speeds. That is, if the motor speed of the primary drive unit 14 is over the knee point (i.e., max torque limit), the maximum torque will reduce gradually. Thus, the measured vehicle speed takes into account the knee point of the drive unit 14. Stated differently, the knee point of the drive unit 14 may be added as a modifier to tune the measured vehicle speed. After determining the vehicle operating parameters, the control algorithm then proceeds to 108.

At 108, the control algorithm, using the controller 38, determines a modification value based on the measured vehicle operating parameters. That is, in one form, the modification value is calculated or determined from a lookup or reference table based on the measured vehicle speed and the pedal rate. Stated differently, for a given vehicle speed and pedal rate, the modification value may be determined using the reference table. In another form, the modification value is calculated or determined from a lookup or reference table based on the measured vehicle speed and the regenerative breaking torque rate. In yet another form, the modification value is calculated or determined from a lookup or reference table based on the measured vehicle speed and the wheel torque rate. In this way, system 25 may operate when the vehicle 10 is in cruise control, for example. After determining the modification value, the control algorithm then proceeds to 112.

At 112, the control algorithm, using the controller 38, determines if the modification value is negative. If the modification value is negative, the control algorithm proceeds to 116, where the controller 38 determines a vehicle speed connect value and a vehicle speed disconnect value based on the determined operating parameters. That is, in one form, the vehicle speed connect value and the vehicle speed disconnect value are calculated or determined from a lookup or reference table based on the measured vehicle speed and the pedal input. In another form, the vehicle speed connect value and the vehicle speed disconnect value are calculated or determined from a lookup or reference table based on the measured vehicle speed and the regenerative breaking torque. In yet another form, the vehicle speed connect value and the vehicle speed disconnect value are calculated or determined from a lookup or reference table based on the measured vehicle speed and the wheel torque.

If the modification value is positive, the control algorithm proceeds to 120, where the controller 38 determines a vehicle speed connect value and a vehicle speed disconnect value based on adjusted vehicle operating parameters. That is, in one form, the vehicle speed connect value and the vehicle speed disconnect value are calculated or determined from a lookup or reference table based on the measured vehicle speed and an adjusted pedal input. The adjusted pedal input may include increasing the measured pedal input by the modification value. In another form, the vehicle speed connect value and the vehicle speed disconnect value are calculated or determined from a lookup or reference table based on the measured vehicle speed and an adjusted regenerative breaking torque. The adjusted regenerative breaking torque may include increasing the measured regenerative breaking toque by the modification value. In yet another form, the vehicle speed connect value and the vehicle speed disconnect value are calculated or determined from a lookup or reference table based on the measured vehicle speed and an adjusted wheel torque. The adjusted wheel torque may include increasing the measured wheel torque by the modification value.

At 124, the control algorithm, using the controller 38, determines if the vehicle speed connect value is greater than the measured vehicle speed. If the vehicle speed connect value is greater than the measured vehicle speed, the control algorithm proceeds to 128, where the controller 38 moves the coupling 33 to the closed position. In this way, the front motor 16 drives the front axle 22 such that the vehicle 10 is in a four-wheel-drive mode or all-wheel-drive mode. The control algorithm proceeds to 144 and ends where it may be ready to return to 104.

If the vehicle speed connect value is less than the measured vehicle speed, the control algorithm proceeds to 132, where the control algorithm determines if the vehicle speed disconnect value is less than the measured vehicle speed. If the vehicle speed connect value is greater than the measured vehicle speed, the controller 38 retains the coupling 33 in its current position. For example, if the coupling 33 is in the closed position, then the coupling 33 is retained in the closed position. In another example, if the coupling 33 is in the open position, then the coupling 33 is retained in the open position. The control algorithm proceeds to 144 and ends where it may be ready to return to 104.

If the vehicle speed disconnect value is less than the measured vehicle speed, the control algorithm proceeds to 140, where the controller 38 moves the coupling 33 to the open position. In this way, the front motor 16 is disconnected from the front axle 22 and the front motor 16 drag loss is removed from the front axle 22. The control algorithm proceeds to 144 and ends where it may be ready to return to 104. The system 25 of the present disclosure provides the benefit increasing the vehicle 10 range and energy efficiency based on timely operation of the coupling 33.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A system for an electric vehicle, the system comprising:
a drive axle configured to drive a set of vehicle wheels;
a motor configured to selectively drive the drive axle;
a sensor configured to measure a vehicle speed;
a coupling configured to move between an open position in which the motor and the drive axle are disconnected from each other and a closed position in which the motor and the drive axle are connected to each other; and
a controller in communication with the motor, the sensor, and the coupling, the controller configured to:
determine a vehicle speed connect value based on a vehicle operating parameter; and
move the coupling to the closed position in response to the vehicle speed connect value being greater than the measured vehicle speed.

2. The system of claim 1, wherein the vehicle speed connect value is determined based on a reference table stored in a memory of the controller.

3. The system of claim 1, wherein the controller is further configured to determine a vehicle speed disconnect value based on the vehicle operating parameter, and wherein the coupling is moved to the open position in response to the vehicle speed connect value being less than the measured vehicle speed and the vehicle speed disconnect value being less than the measured vehicle speed.

4. The system of claim 1, wherein the vehicle speed connect value is determined based on the vehicle operating parameter and the measured vehicle speed.

5. The system of claim 1, wherein the vehicle operating parameter is one of a pedal input, regenerative torque, and a wheel torque.

6. The system of claim 1, wherein the measured vehicle speed takes into account a primary drive unit torque limit.

7. A system for an electric vehicle, the system comprising:
a drive axle configured to drive a set of vehicle wheels;
a motor configured to selectively drive the drive axle;
a sensor configured to measure a vehicle speed;
a coupling configured to move between an open position in which the motor and the drive axle are disconnected from each other and a closed position in which the motor and the drive axle are connected to each other; and
a controller in communication with the motor, the sensor, and the coupling, the controller configured to:
determine a modification value based on the measured vehicle speed and a first vehicle operating parameter;
determine whether the modification value is negative;
adjust a second vehicle operating parameter by the modification value in response to the modification value being negative;
determine a vehicle speed connect value based on the adjusted second vehicle operating parameter; and
move the coupling to the closed position in response to the vehicle speed connect value being greater than the measured vehicle speed.

8. The system of claim 7, wherein the modification value is determined based on a reference table stored in a memory of the controller.

9. The system of claim 7, wherein the first vehicle operating parameter is one of a pedal rate, regenerative torque rate, and a wheel torque rate.

10. The system of claim 7, wherein the vehicle speed connect value is determined based on a reference table stored in a memory of the controller.

11. The system of claim 7, wherein adjusting the second vehicle operating parameter by the modification value comprises increasing the second vehicle operating parameter by the modification value.

12. The system of claim 7, wherein the controller is further configured to determine a vehicle speed disconnect value based on the vehicle operating parameter, and wherein the coupling is moved to the open position in response to the vehicle speed connect value being less than the measured vehicle speed and the vehicle speed disconnect value being less than the measured vehicle speed.

13. The system of claim 7, wherein the vehicle speed connect value is determined based on the adjusted second vehicle operating parameter and the measured vehicle speed.

14. The system of claim 7, wherein the second vehicle operating parameter is one of a pedal input, regenerative torque, and a wheel torque.

15. A method comprising:
determining a modification value based on a measured vehicle speed and a first vehicle operating parameter;
determining whether the modification value is negative;
adjusting a second vehicle operating parameter by the modification value in response to the modification value being negative;
determining a vehicle speed connect value based on the adjusted second vehicle operating parameter; and
moving a coupling to a closed position in response to the vehicle speed connect value being greater than the measured vehicle speed, the coupling connecting a motor and a drive axle to each other when in the closed position.

16. The method of claim 15, wherein the modification value is determined based on a reference table stored in a memory of a controller.

17. The method of claim 15, wherein the first vehicle operating parameter is one of a pedal rate, regenerative torque rate, and a wheel torque rate.

18. The method of claim 15, wherein the vehicle speed connect value is determined based on a reference table stored in a memory of a controller.

19. The method of claim 15, wherein adjusting the second vehicle operating parameter by the modification value comprises increasing the second vehicle operating parameter by the modification value.

20. The method of claim 15, further comprising:
determining a vehicle speed disconnect value based on the adjusted second vehicle operating parameter; and
moving the coupling to an open position in response to the vehicle speed connect value being less than the measured vehicle speed and the vehicle speed disconnect value being less than the measured vehicle speed, the coupling disconnecting the motor and the drive axle from each other when in the closed position.
